(19) United States
(12) Patent Application Publication
(10) Pub. No.: US 2025/0305858 A1
(43) Pub. Date: Oct. 2, 2025

(54) ANNULAR SMALL-PERIOD-LONG-PERIOD FIBER GRATING SENSOR, PREPARATION METHOD AND APPLICATIONS THEREOF

(71) Applicant: HUAZHONG UNIVERSITY OF SCIENCE AND TECHNOLOGY, Wuhan (CN)

(72) Inventors: Xuewen SHU, Wuhan (CN); Jintao CAI, Wuhan (CN); Lin ZHANG, Birmingham (GB)

(73) Assignee: HUAZHONG UNIVERSITY OF SCIENCE AND TECHNOLOGY, Wuhan (CN)

(21) Appl. No.: 19/056,757

(22) Filed: Feb. 19, 2025

Related U.S. Application Data
(63) Continuation of application No. PCT/CN2024/086951, filed on Apr. 10, 2024.

(30) Foreign Application Priority Data
Apr. 2, 2024 (CN) 202410396477.X

(51) Int. Cl. G01D 5/353; G02B 6/02

(52) U.S. Cl. CPC G01D 5/3538; G01D 5/35374; G02B 6/02033

(57) ABSTRACT

An annular small-period-long-period fiber grating (SP-LPG) sensor, a preparation method and applications thereof are provided. The annular (SP-LPG) sensor matches the cross-section shape of the optical fibers, the annulus can expand the area of the refractive index modulation region more effectively in the section of the optical fibers, so that the annular grating has a large refractive index modulation region in both the axial and longitudinal directions of the optical fibers, which can simultaneously enhance the intensity of the Bragg resonance peak and the resonance peaks of the cladding modes. Therefore, the Bragg resonance peak and the resonance peaks of the cladding modes can be observed simultaneously in the transmission spectra. It can realize the simultaneous measurement of the refractive index and temperature of the surrounding environment without the need to observe the reflection peak, which simplifies the multi-parameter sensing test steps of the (SP-LPG) sensor.

### CROSS REFERENCE TO THE RELATED APPLICATIONS

This application is a continuation application of International Application No. PCT/CN2024/086951, filed on Apr. 10, 2024, which is based upon and claims priority to Chinese Patent Application No. 202410396477.X, filed on Apr. 2, 2024, the entire contents of which are incorporated herein by reference.

### TECHNICAL FIELD

The present disclosure relates to the technical field of optical fiber sensing, and in particular to an annular small-period-long-period fiber grating sensor, a preparation method and applications thereof.

### BACKGROUND

Fiber grating sensors are widely used in aerospace, food safety, biomedicine and other fields due to their advantages of small size, high sensitivity, corrosion resistance and anti-electromagnetic interference. Fiber Bragg grating (FBG) and long-period fiber grating (LPG) sensors are the most extensively utilized fiber grating sensors. The period of FBG is usually less than 1 micron, which can perform reverse coupling on the core mode, mainly used in temperature and strain sensing, etc. The period of LPG is generally between tens to hundreds of microns, which can couple the fundamental core mode to the cladding modes, therefore, it can sense the external environment outside the cladding and can be used in biochemical molecular sensing and other fields.

At present, it has been reported that a small-period long-period fiber grating (SP-LPG) with a period of several tens of microns. The grating is characterized by both the Bragg reflection peak and resonance peaks of the cladding modes, thus realizing multi-parameter sensing. However, the current preparation method of a SP-LPG is limited to the way of horizontal line-by-line writing. Although the preparation method is simple, the Bragg resonance peak is often too weak to be observed in the transmission spectrum. Therefore, when using the SP-LPG for multi-parameter sensing, it is necessary to simultaneously acquire its reflection spectrum and transmission spectrum, which increases the complexity of the detection step.

### SUMMARY

An objective of the present disclosure is to provide an annular small-period-long-period fiber grating (SP-LPG) sensor, a preparation method and applications thereof. The device has a compact structure, simple preparation, and high refractive index sensitivity, and the sensor can simultaneously detect the Bragg resonance peak and resonance peaks of the cladding modes in the transmission spectrum, which simplifies subsequent extraction steps for multi-parameter sensing signals.

In order to achieve the above effects, the present disclosure adopts the following technical solutions.

The present disclosure provides an annular SP-LPG sensor, including an optical fiber, an interior of a fiber core of the optical fiber is provided with refractive index modulation units periodically distributed along an axial direction of the fiber core, the refractive index modulation unit of each period includes annuli arranged in series, each of which is perpendicular to the fiber core axis, with the centers of the annuli coinciding with the fiber core.

The refractive index modulation units are formed by laser processing.

Preferably, the refractive index modulation units are periodically distributed along the axial direction of the fiber core according to a specific duty ratio; and the specific duty ratio is 1-50%.

Preferably, the optical fiber is a single-mode fiber; and the laser is a femtosecond laser.

Preferably, a diameter of the annulus is 1-10 μm, a number of annuli in each refractive index modulation unit is 1-10, a distance between the annuli in each refractive index modulation unit is 0.1-2 μm, a distance between adjacent refractive index modulation units is 10-80 μm, and a number of refractive index modulation units is 50-200.

The present disclosure provides a preparation method of the annular SP-LPG sensor described in the above technical solution, including the following steps:
focusing a laser on a fiber core of an optical fiber, setting parameters of the laser and a translation platform, the laser is incident vertically into interiors of the fiber cores, to form the annular SP-LPG sensor.

Preferably, conditions of the laser include as follows: a wavelength of the femtosecond pulse laser is 520 nm, a repetition rate is 100-200 kHz, and an energy is 10-200 nJ.

The present disclosure provides applications of the annular SP-LPG sensor described in the above technical solution or the annular SP-LPG sensor prepared by the preparation method described in the above technical solution in a fiber-optic biochemical sensor or a temperature sensor.

Preferably, when the annular SP-LPG sensor is applied to the fiber-optic biochemical sensor, a preparation method of the fiber-optic biochemical sensor includes:
activating the annular SP-LPG sensor in an acid solution or alkaline solution, to obtain a hydroxylated optical fiber;
mixing the hydroxylated optical fiber with a silane organic compound with a terminal amino group, to obtain an aminated optical fiber:
mixing the aminated optical fiber with a gold nanoparticles dispersion solution, for loading, to obtain a gold nanoparticles-modified optical fiber;
mixing the gold nanoparticles-modified optical fiber with 11-mercaptoundecanoic acid solution for carboxylation, to obtain a carboxylated gold nanoparticles-modified optical fiber; and
mixing the carboxylated gold nanoparticles-modified optical fiber, a solution of protein antibodies, 1-ethyl-(3-dimethylaminopropyl) carbodiimide and N-hydroxysuccinimide for antibodyization, to obtain the fiber-optic biochemical sensor.

Preferably, the silane organic compound with the terminal amino group includes 3-aminopropyltriethoxysilane; a temperature of the amination is 20-40° C., with a time of 8-12 h; a temperature of the loading is room temperature, with a time of 3-10 h; and a temperature of the carboxylation is 20-40° C., with a time of 3-8 h.

Preferably, protein antibodies in the solution of the protein antibodies include a carcinoembryonic antigen antibody, an alpha-fetoprotein antibody or a virus antibody, and a concentration of the solution of the protein antibodies is 1-100 μg/mL; and a temperature of the antibodyization is 0-10° C., with a time of 8 h.

The present disclosure provides an annular SP-LPG sensor, including an optical fiber, an interior of a fiber core of the optical fiber is provided with refractive index modulation units periodically distributed along an axial direction of the fiber core, the refractive index modulation unit of each period includes annuli arranged in series, each of which is perpendicular to the fiber core axis, with the centers of the annuli coinciding with the fiber core. The annular SP-LPG sensor of the present disclosure matches the cross-section shape of the optical fiber, the annuli can expand the area of the refractive index modulation region more effectively in the section of the optical fiber, so that the annular grating has a large refractive index modulation region in both the axial and longitudinal directions of the optical fiber, which can simultaneously enhance the intensity of the Bragg resonance peak and resonance peaks of the cladding modes. Therefore, the Bragg resonance peak and the resonance peaks of the cladding modes can be observed simultaneously in the transmission spectrum. It can realize the simultaneous measurement of the refractive index and temperature of the surrounding environment without the need to observe the reflection peak, which simplifies the multi-parameter sensing test steps of the SP-LPG sensor.

Compared with the prior art, the annular SP-LPG sensor provided by the present disclosure has the following advantages:
1) the femtosecond laser is adopted to process the fiber grating to ensure the integrity of the optical fiber. This enables its use in the sensor, guaranteeing robustness and resistance to external environmental interference.
2) simple processing, high flexibility and reproducibility, and the prepared device has a compact structure;
3) it can be used for multi-parameter sensing simultaneously, such as temperature and biochemical molecule detection; and
4) most reported fiber gratings are fabricated through line by line writing along the fiber cores, while the fiber grating in the present disclosure is centered on the fiber cores, fabricated by writing annuli along an axial direction of fiber cores; and the pattern of multiple annuli forming a period makes the refractive index modulation area larger than that of line-by-line writing. The effects of the multi-annular gratings in the present disclosure are reflected in both a small-period periodic modulation zone in the axial direction of the fiber core and also a modulation zone in the direction perpendicular to the fiber core. The combined action of the two modulation regions in the transverse and longitudinal directions makes it possible to simultaneously observe the Bragg resonance peak and the resonance peaks of the cladding modes in the transmission spectra.

### BRIEF DESCRIPTION OF THE DRAWINGS

FIG. 1 shows a structure diagram of an annular SP-LPG sensor prepared in the present disclosure and a schematic diagram of spectra coupling thereof;

FIG. 2 is a schematic diagram of a biological modification process of an annular SP-LPG sensor in the present disclosure;

FIG. 3 is a schematic diagram of a biomolecular detection device in the present disclosure;

FIGS. 4A-4D show temperature sensing result diagrams of an annular SP-LPG sensor in the present disclosure; wherein, FIG. 4A shows curves of the Bragg resonance peak and resonance peaks of cladding modes at different temperatures in transmission spectra; FIG. 4B shows linear relationship curves of the wavelength shift in the Bragg resonance peak and the resonance peaks of cladding modes with the temperature change; FIG. 4C shows curves of the change in the Bragg resonance peak over temperature; and FIG. 4D shows curves of the change in the resonance peaks of cladding modes over temperature;

FIGS. 5A-5B show refractive index sensing result diagrams of an annular SP-LPG sensor in the present disclosure; wherein, FIG. 5A shows curves of the change in resonance peaks of cladding modes over external refractive index in transmission spectra; and FIG. 5B shows curves of change relationship in the wavelength shift of the resonance peaks over refractive index; and

FIGS. 6A-6D shows results of measuring a carcinoembryonic antigen (CEA) by an annular SP-LPG sensor in the present disclosure; wherein, FIG. 6A shows curves of the change in resonance peaks of cladding modes over time in transmission spectra when a concentration of CEA is 10 ng/ml; FIG. 6B shows drawings of partial enlargement of the curves in FIG. 6A; FIG. 6C shows curves of the change in resonance peaks of cladding modes over time in transmission spectra when a concentration of CEA is 1 ng/mL; and FIG. 6D shows drawings of partial enlargement of the curves in FIG. 6C.

### DETAILED DESCRIPTION OF THE EMBODIMENTS

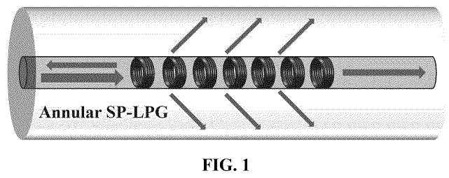

As shown in FIG. 1, the present disclosure provides an annular SP-LPG sensor, including an optical fiber, an interior of a fiber core of the optical fiber is provided with refractive index modulation units periodically distributed along an axial direction of the fiber core, the refractive index modulation unit of each period includes annuli arranged in series, each of which is perpendicular to the fiber core axis, with the centers of the annuli coinciding with the fiber core.

The refractive index modulation units are formed by laser processing.

In the present disclosure, unless otherwise specified, raw materials or reagents required are well-known commercially available products for those skilled in the art.

In the present disclosure, the refractive index modulation units are periodically distributed along the axial direction of the fiber core according to a specific duty ratio; and the specific duty ratio is preferably 1-50%, and more preferably 5%.

In the present disclosure, the optical fiber is preferably a single-mode fiber; and the laser is preferably a femtosecond laser.

In the present disclosure, a diameter of the annulus is preferably 1-10 μm, and more preferably 6 μm; a number of annuli in each refractive index modulation unit is preferably 1-10, and more preferably 4; a distance between the annuli in each refractive index modulation unit is preferably 0.1-2 μm, and more preferably 0.5 μm; a distance between adjacent refractive index modulation units is preferably 10-80 μm, and more preferably 30 μm; and a number of refractive index modulation units is preferably 50-200, and more preferably 100.

The present disclosure provides a preparation method of the annular SP-LPG sensor described in the above technical solution, including the following steps:
a laser is focused on the fiber core of the optical fiber, parameters of the laser and a translation platform are set, the laser is incident vertically into the interior of the fiber core, to form the annular SP-LPG sensor.

In a preferred embodiment of the present disclosure, the optical fiber is fixed on a three-dimensional translation platform, so that the femtosecond laser can be incident vertically into the interior of the fiber core; the translation platform is adjusted, so that the laser is focused on the fiber cores; after setting the parameters of the femtosecond laser and the translation platform, the annular SP-LPG sensor is prepared at the interior of the fiber core according to a specific duty ratio.

In the present disclosure, the laser is focused on the fiber core, and the refractive index modulation region and shape are adjusted by the movement of the translation platform. There is no special limitation on the process of setting the parameters of the translation platform in the present disclosure, and it is simply ensured that the laser is incident vertically into the interior of the fiber core.

In the present disclosure, conditions of the laser preferably include: a wavelength of the femtosecond pulse laser is 520 nm, a repetition rate is 100-200 kHz, and more preferably 200 kHz, and an energy is 10-200 nJ, and more preferably 60 nJ.

The present disclosure provides applications of the annular SP-LPG sensor described in the above technical solution or the annular SP-LPG sensor prepared by the preparation method described in the above technical solution in a fiber-optic biochemical sensor or a temperature sensor.

In the present disclosure, when the annular SP-LPG sensor is applied to the fiber-optic biochemical sensor, a preparation method of the fiber-optic biochemical sensor preferably includes:
an activation is performed on the annular SP-LPG sensor in an acid solution or alkaline solution, to obtain a hydroxylated optical fiber;
the hydroxylated optical fiber is mixed with a silane organic compound with a terminal amino group and a mixed solvent for amination, to obtain an aminated optical fiber:
the aminated optical fiber is mixed with a gold nanoparticle dispersion solution, for loading, to obtain a gold nanoparticles-modified optical fiber;
the gold nanoparticles-modified optical fiber is mixed with 11-mercaptoundecanoic acid solution for carboxylation, to obtain a carboxylated gold nanoparticles-modified optical fiber; and
the carboxylated gold nanoparticles-modified optical fiber, a solution of protein antibodies, 1-ethyl-(3-dimethylaminopropyl) carbodiimide (EDC) and N-hydroxysuccinimide (NHS) are mixed for antibodyization, to obtain the fiber-optic biochemical sensor.

In the present disclosure, the acid solution is preferably a mixture of concentrated sulfuric acid and 30 wt % hydrogen peroxide, and a volume ratio of concentrated sulfuric acid and 30 wt % hydrogen peroxide is preferably 1:1-3:1; when the acid solution is adopted, a temperature of the activation is preferably 20-50° C., and a time of the activation is preferably 1-4 h.

In the present disclosure, the surface of the optical fiber is cleaned by the acid solution or the alkali solution, and silanol groups on the surface of the optical fiber are activated.

After the activation is completed, residues on the surface of the optical fiber are washed with deionized water and blown dry with N₂.

In the present disclosure, the silane organic compound with the terminal amino group includes 3-aminopropyltriethoxysilane (APTES); the mixed solvent is preferably water and ethanol, wherein, calculated based on a total volume of the silane organic compound with the terminal amino group and the mixed solvent as 100%, a volume ratio of APTES is preferably 0.5-2%, and more preferably 1%; a volume ratio of ethanol is preferably 0.5-2%, and more preferably 1%; and the volume ratio of water is preferably 96-99%, and more preferably 98%.

In a preferred embodiment of the present disclosure, the hydroxylated fiber grating is soaked in a mixture of the silane organic compound with the terminal amino group and the mixed solvent; a temperature of the amination is preferably 20-40° C., and more preferably 25° C.; and a time of the amination is preferably 8-12 h.

After the amination is completed, in a preferred embodiment of the present disclosure, products are cleaned with ethanol and blown dry with N₂.

In the present disclosure, a preparation method of the gold nanoparticle dispersion solution is preferably as follows: sodium citrate aqueous solution (75 mL, 2.2 mM), tannic acid aqueous solution (0.5 μL, 2.5 mM) and K₂CO₃ aqueous solution (0.5 mL, 150 mM) were mixed with reduced chloroauric acid aqueous solution (0.5 mL, 25 mM) to obtain a mixed solution, and after the mixed solution was reduced at 100° C. for 20 min, the gold nanoparticle dispersion solution was obtained; and a concentration of the gold nanoparticle dispersion solution is preferably 0.01-0.1 M, and more preferably 0.02 M.

In a preferred embodiment of the present disclosure, the aminated fiber grating is soaked in the aminated fiber grating; a temperature of the loading is preferably room temperature (25° C.), a time of the loading is preferably 3-10 h, and more preferably 8 h. In et the present disclosure, gold nanoparticles are loaded on the optical fiber by using the method of charge attraction.

After the loading, in a preferred embodiment of the present disclosure, obtained products are rinsed with deionized water and blown dry with N₂.

In the present disclosure, a concentration of the 11-mercaptoundecanoic acid solution (MUA, ethanol solution) is preferably 0.1-1 mM, and more preferably 0.5 mM; a preferred embodiment of the present disclosure is to soak the gold nanoparticles-modified optical fiber in the 11-mercaptoundecanoic acid solution; and a temperature of the carboxylation is preferably 20-40° C., and a time of the carboxylation is 3-8 h, and more preferably 5 h.

After the carboxylation is completed, in a preferred embodiment of the present disclosure, obtained products are washed with absolute ethanol, and blown dry with N₂.

In the present disclosure, protein antibodies in the solution of the protein antibodies preferably include a carcinoembryonic antigen antibody, an alpha-fetoprotein antibody or a virus antibody; a molar ratio of 1-ethyl-3-(3-dimethylaminopropyl) carbodiimide hydrochloride (EDC) and N-Hydroxysuccinimide (NHS) is preferably 1:1-5:1, and more preferably 4:1; a concentration of the solution of the protein antibodies is preferably 1-100 μg/mL, and more preferably 10 μg/mL; and a solvent used is preferably phosphate buffered salin solution (PBS), and pH=7.4.

In a preferred embodiment of the present disclosure, the carboxylated gold nano-modified fiber is treated in a mixed aqueous solution of EDC and NHS for 10-30 min, and then soaked in the solution of the protein antibodies for antibodyization. There is no special limitation on the concentration of the mixed aqueous solution of EDC and NHS, and it is simply adjusted according to actual demands.

In the present disclosure, a temperature of the antibodyization is preferably 0-10° C., and more preferably 4° C., and a time of the antibodyization is preferably 8 h.

After the antibodyization is completed, in a preferred embodiment of the present disclosure, antibodies that are not loaded firmly are washed with deionized water and stored at 0-4° C.

In the present disclosure, the protein antibodies are loaded on the gold nanoparticles to complete the antibodyization of the optical fiber and endow the optical fiber with a specific recognition function.

In the present disclosure, the fiber-optic biochemical sensor is suitable for all kinds of molecular detection with the protein antibodies as recognition body, such as the detection of immunoglobulins, streptavidin, virus or bacterial substances.

In the following, the technical solutions provided by the present disclosure are described in detail in combination with the embodiments, but they cannot be understood as limiting the scope of protection of the present disclosure.

### Embodiment 1

As shown in FIG. 1, in an annular SP-LPG sensor provided by the present embodiment, a refractive index modulation unit included four annuli, a diameter of the annulus was 6 μm, a distance between different annuli within one refractive index modulation unit was 0.5 μm, a distance between adjacent refractive index modulation units was 30 μm (referring to the distance between the last annulus of the previous modulation unit and the first annulus of the next modulation unit), and a total of 100 refractive index modulation units; and the refractive index modulation units were periodically distributed along the axial direction of the fiber core according to a duty ratio of 5%.

A preparation method of the annular SP-LPG sensor was:
1) an optical fiber was fixed on a three-dimensional translation platform, so that the axial direction of the optical fiber was perpendicular to the incident direction of the laser beam; in order to counteract the influence of the cylindrical shape of the optical fiber on the focusing of the laser, the refractive index matching oil was added between the lens and the optical fiber; the position of the optical fiber was observed and adjusted by a microscope, so that the laser beam output by the laser was focused on the center of the fiber through a microscopic objective lens (numerical aperture of 1.4, 63×) and an adjustable aperture;
2) After setting parameters of femtosecond laser and translation platform, the annular SP-LPG sensor was prepared;
wherein, the femtosecond pulse laser wavelength was that a femtosecond laser pulse worked at 520 nm, the repetition rate was 200 kHz and the energy was 60 nJ.

### Embodiment 2

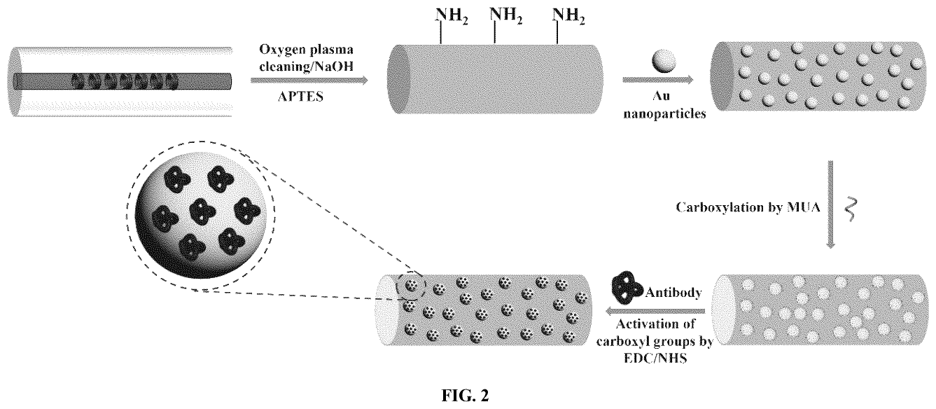

As shown in FIG. 2, taking the carcinoembryonic antigen antibody as an example, the biological modification of optical fiber was performed.
1) hydroxylation of the optical fiber: the optical fiber was treated in an oxygen plasma cleaner for 3 min, and a radio frequency power supply was 50 W, the obtained optical fiber was soaked in 0.2 M sodium hydroxide solution and treated at 40° C. for 3.5 h, and residues on the surface of the optical fiber were washed with deionized water and blown dry with N₂;
2) amination of the optical fiber: a hydroxylated optical fiber was soaked in 1% 3-aminopropyltriethoxysilane (APTES) solution (a volume ratio of APTES:ethanol:water was 1:1:98 ), amination was performed at room temperature for 12 h, being washed by ethanol and blown dry with N₂;
3) loading of gold nanoparticles: sodium citrate aqueous solution (75 mL, 2.2 mM), tannic acid aqueous solution (0.5 μL, 2.5 mM) and K₂CO₃ aqueous solution (0.5 mL, 150 mM) were used to reduce chloroauric acid aqueous solution (0.5 mL, 25 mM) in a flask at 100° C. for 20 min, then a gold nanoparticle dispersion solution (0.02 M) was obtained; the above-mentioned aminated optical fiber was soaked in the gold nanoparticle dispersion solution (10 mL, 0.02 M) for 8 h, being rinsed with deionized water and blown dry with N₂;
4) carboxylation of gold nanoparticles: the obtained gold nanoparticle-loaded fiber from the above step 3) was soaked in 5 mL 0.5 mM 11-mercaptoundecanoic acid (MUA, ethanol solution) at 25° C. for 5 h, being washed with absolute ethanol and blown dry with N₂, and a carboxylated gold nanoparticles-modified optical fiber was obtained; and
5) modification of protein antibodies: the carboxylated gold nanoparticles-modified optical fiber was treated in a 10 mL mixed aqueous solution of EDC (100 mM) and NHS (25 mM) for 10 min, then soaked in 10 μg/mL carcinoembryonic antigen (CEA) antibody solution (PBS, pH=7.4) and treated at 4° C. for 8 h. The fiber was then rinsed with deionized water to remove any loosely bound antibodies, and stored in a refrigerator at 0-4° C. A fiber-optic biochemical sensor was thus obtained.

### Embodiment 3

### Temperature Sensing Experiment

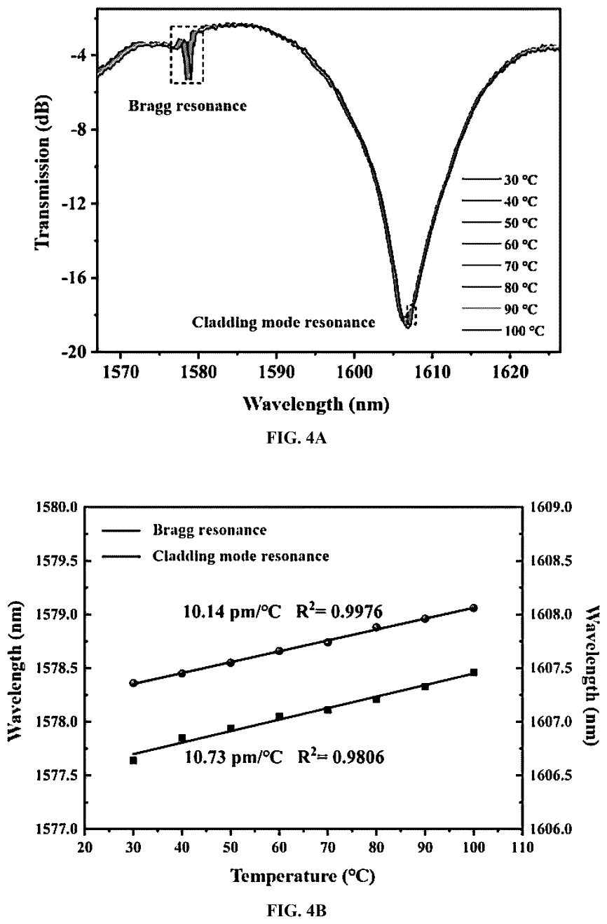

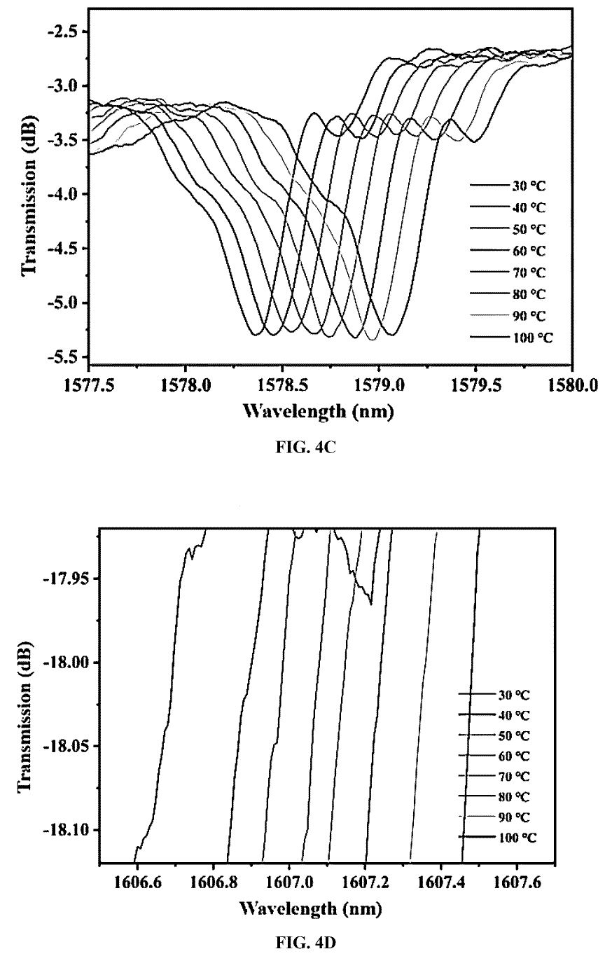

The annular small-period long-period fiber grating sensor of Embodiment 1 was fixed in a temperature control box, to prevent the optical fiber jitter, the temperature control was adjusted, taking 30° C. as a start temperature, the transmission spectra were recorded, the spectra of 40-100° C. were gradually recorded at an increment of 10° C., and the results were shown in FIGS. 4A-4D, wherein, FIG. 4A showed curves of the Bragg resonance peak and the resonance peaks of cladding modes at different temperatures in the transmission spectra; FIG. 4B showed linear relationship curves of the wavelength shift in the Bragg resonance peak and the resonance peaks of cladding modes with the temperature change; FIG. 4C showed curves of the change in the Bragg resonance peak over temperature; and FIG. 4D showed curves of the change in the resonance peaks of cladding modes over temperature.

In the transmission spectra shown in FIG. 4A, the sharper on the left was the Bragg resonance peak, and the ones on the right were the resonance peaks of cladding modes. It could be clearly seen from the drawing of partial enlargement of the Bragg resonance peak shown in FIG. 4C that the Bragg resonance peak gradually showed red shift with the increase of temperature, and a temperature sensitivity obtained by linear fitting in FIG. 4B was 10.14 pm/° C.; at the same time, a similar phenomenon was also observed from the drawing of partial enlargement of the resonance peaks of cladding modes in FIG. 4D, and a similar temperature sensitivity of 10.73 pm/° C. was obtained in FIG. 4B.

Therefore, the Bragg resonance peak in the transmission spectra of the present disclosure could be used to monitor the temperature change of the environment, to prevent the temperature change from causing experimental interference to the refractive index sensing.

### Embodiment 4

### Refractive Index Sensing Experiment

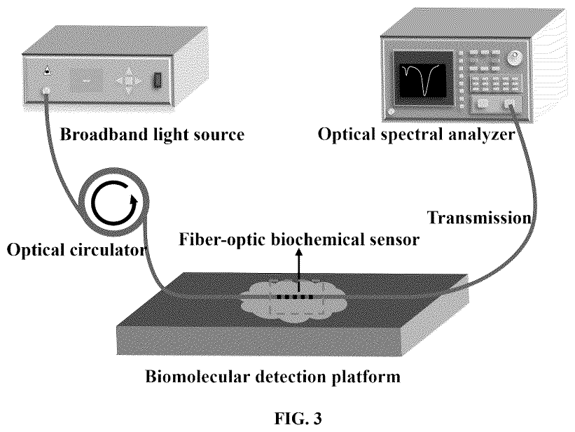

FIG. 3 showed a refractive index sensing device. The light source was connected to a optical circulator, an output interface of the optical circulator was connected to the small-period long-period fiber grating sensor described in Embodiment 1, and another interface of the sensor was connected to the spectrum analyzer; and the sensing area of the fiber grating sensor was placed in the detection groove, one end was attached to the track groove of the detection groove, and the other end was straightened under tension. Finally, the two ends of the sensor were fixed to the track groove with ultraviolet glue to prevent any stretching or vibration.

The solution with the refractive index between 1.333 and 1.410 was configured by adjusting the ratio of glycerol to water (the refractive indexes were 1.333, 1.34, 1.35, 1.36, 1.37, 1.38, 1.39, 1.40, and 1.41, respectively), the refractive index sensing experiment of the small-period long-period fiber grating sensor described in Embodiment 1 was performed, and the volume of the solution added to the detection groove each time was 1 mL.

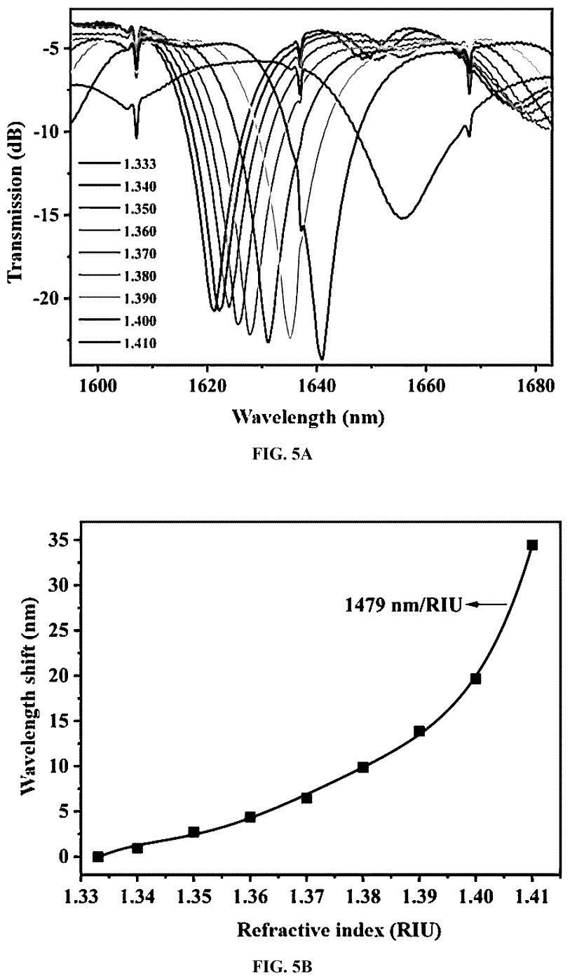

The results were shown in FIGS. 5A-5B, wherein FIG. 5A showed curves of the change in resonance peaks of cladding modes over external refractive index in transmittance spectra, and FIG. 5B showed curves of change relationship in the wavelength shift of resonance peaks over refractive index; as shown in FIG. 5A, as the refractive index increased, the wavelength of the transmission spectrum gradually showed red shift, while the Bragg resonance peak did not change with the refractive index; through the fitting curve of the change relationship between the wavelength shift and the refractive index of FIG. 5B, it could be seen that the refractive index sensitivity between 1.40-1.41 reached 1479 nm/RIU.

### Embodiment 5

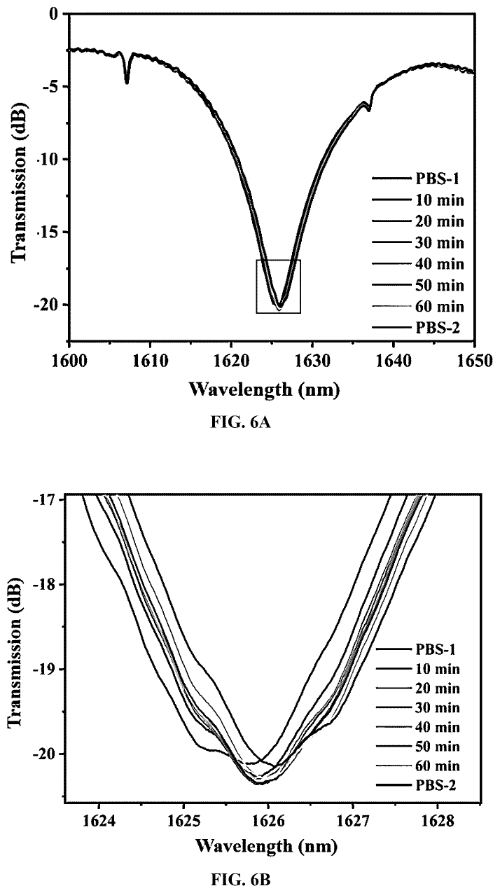

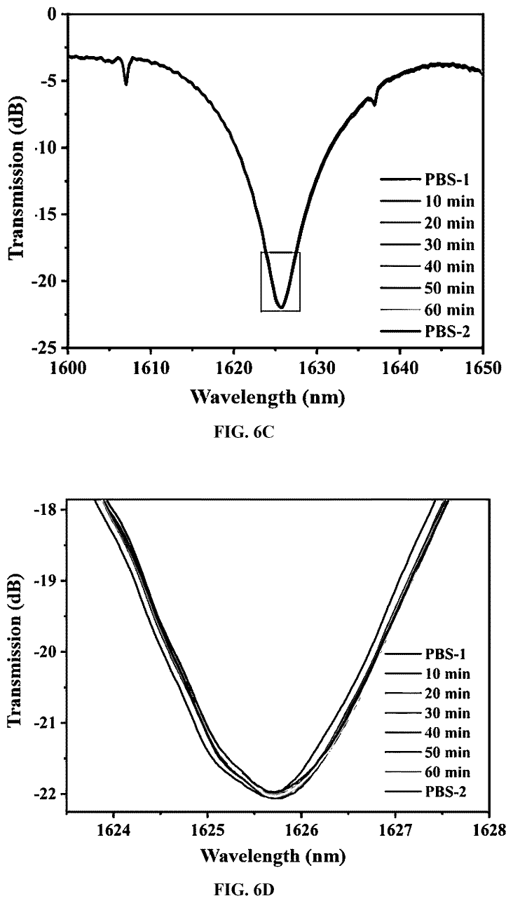

Taking the detection of carcinoembryonic antigen (CEA) as an example, the experimental detection device used the device shown in FIG. 3;
1) the detection of CEA was carried out at 25° C., based on the fiber-optic biochemical sensor prepared in Embodiment 2, the sensing area was fixed in the detection groove, 1 mL of PBS solution was added, waiting for the spectrum to stabilize, the position of the resonance wavelength at this time was recorded and used as the baseline spectrum (denoted as PBS-1, λ0).
2) The PBS solution in step 1) was removed from the detection groove, then 1 mL of PBS solution containing 10 ng/mL CEA was added, the spectra were recorded once every 10 minutes, after 60 minutes, the resonance wavelength position was stable, indicating that the antigen and antibody reached a biochemical equilibrium state. After that, the sensing area was cleaned with deionized water to remove the detection substances with physical bonding of surface adhesion.
3) The rinsed sensing area was placed in 1 mL of PBS solution, the spectrum reached a stable state as the final spectrum (denoted as PBS-2, λ1). The difference between the baseline spectrum and the final spectrum (Δλ=λ1−λ0) was used as the wavelength shift for each concentration, and the results were shown in FIG. 6A and FIG. 6B. When the concentration of CEA was 10 ng/mL, the wavelength of the spectrum was red-shifted by 0.32 nm. At the same time, this calculation method effectively avoided the error caused by the volume refractive index in the experimental results. In FIGS. 6A-6D, PBS-1 and PBS-2 represented the spectrogram of the sensor in pure PBS solution before testing and the spectrogram of the sensor in pure PBS solution after completing CEA recognition, respectively;
4) the detection process of 1 ng/mL CEA was the same as the above, and the results were shown in FIG. 6C. FIG. 6C showed curves of the change in resonance peaks of cladding modes over time in the transmission spectra when the concentration of CEA was 1 ng/ml; and FIG. 6D showed drawings of partial enlargement of the curves in FIG. 6C; and
it could be seen from FIG. 6C and FIG. 6D that, when the CEA concentration is 1 ng/ml, the spectral wavelength drift after the testing was 0.07 nm, which was higher than the wavelength resolution (0.02 nm), which showed that the sensor could detect 1 ng/mL, lower than the normal reference concentration of 5 ng/mL CEA, indicating that the CEA fiber grating sensor had certain practicability.

The above descriptions are only the preferred embodiments of the present disclosure. It is to be pointed out that those of ordinary skill in the art can also make several improvements and modifications without departing from the principle of the present disclosure, and such improvements and modifications shall fall within the protection scope of the present disclosure.

What is claimed is:

1. An annular small-period-long-period fiber (SP-LPG) grating sensor, comprising an optical fiber, wherein an interior of a fiber core of the optical fiber is provided with refractive index modulation units periodically distributed along an axial direction of the fiber core, the refractive index modulation unit of each period comprises annuli arranged in series, each of annuli is perpendicular to a fiber core axis, with centers of the annuli coinciding with the fiber core; and
the refractive index modulation units are formed by laser processing.

2. The annular SP-LPG sensor according to claim 1, wherein the refractive index modulation units are periodically distributed along the axial direction of the fiber core according to a specific duty ratio; and the specific duty ratio is 1-50%.

3. The annular SP-LPG sensor according to claim 1, wherein the optical fiber is a single-mode fiber; and a laser is a femtosecond laser.

4. The annular SP-LPG sensor according to claim 1, wherein a diameter of the annulus is 1-10 μm, a number of annuli in each refractive index modulation unit is 1-10, a distance between the annuli in each refractive index modulation unit is 0.1-2 μm, a distance between adjacent refractive index modulation units is 10-80 μm, and a number of the refractive index modulation units is 50-200.

5. A preparation method of the annular SP-LPG sensor according to claim 1, comprising the following steps:
focusing a laser on the fiber core of the optical fiber, setting parameters of the laser and a translation platform, the laser is incident vertically into the interiors of the fiber cores, to form the annular SP-LPG sensor.

6. The preparation method according to claim 5, wherein conditions of the laser are as follows: a wavelength of a femtosecond pulse laser is 520 nm, a repetition rate is 100-200 kHz, and an energy is 10-200 nJ.

7. A method of using the annular SP-LPG sensor according to claim 1 in a fiber-optic biochemical sensor or a temperature sensor.

8. The method according to claim 7, wherein when the annular SP-LPG sensor is applied to the fiber-optic biochemical sensor, a preparation method of the fiber-optic biochemical sensor comprises:
activating the annular SP-LPG sensor in an acid solution or alkaline solution, to obtain a hydroxylated optical fiber;
mixing the hydroxylated optical fiber with a silane organic compound with a terminal amino group and a mixed solvent for amination, to obtain an aminated optical fiber;
mixing the aminated optical fiber with a gold nanoparticle dispersion solution, for loading, to obtain a gold nanoparticles-modified optical fiber;
mixing the gold nanoparticles-modified optical fiber with 11-mercaptoundecanoic acid solution for carboxylation, to obtain a carboxylated gold nanoparticles-modified optical fiber; and
mixing the carboxylated gold nanoparticles-modified optical fiber, a solution of protein antibodies, 1-ethyl-(3-dimethylaminopropyl) carbodiimide, and N-hydroxysuccinimide for antibodyization, to obtain the fiber-optic biochemical sensor.

9. The method according to claim 8, wherein the silane organic compound with the terminal amino group comprises 3-aminopropyltriethoxysilane; a temperature of the amination is 20-40° C., with a time of 8-12 h; a temperature of the loading is room temperature, with a time of 3-10 h; and a temperature of the carboxylation is 20-40° C., with a time of 3-8 h.

10. The method according to claim 8, wherein the protein antibodies in the solution of the protein antibodies comprise a carcinoembryonic antigen antibody, an alpha-fetoprotein antibody, or a virus antibody, and a concentration of the solution of the protein antibodies is 1-100 μg/mL; and a temperature of the antibodyization is 0-10° C., with a time of 8 h.

11. The preparation method according to claim 5, wherein in the annular SP-LPG sensor, the refractive index modulation units are periodically distributed along the axial direction of the fiber core according to a specific duty ratio; and the specific duty ratio is 1-50%.

12. The preparation method according to claim 5, wherein in the annular SP-LPG sensor, the optical fiber is a single-mode fiber; and the laser is a femtosecond laser.

13. The preparation method according to claim 5, wherein in the annular SP-LPG sensor, a diameter of the annulus is 1-10 μm, a number of annuli in each refractive index modulation unit is 1-10, a distance between the annuli in each refractive index modulation unit is 0.1-2 μm, a distance between adjacent refractive index modulation units is 10-80 μm, and a number of the refractive index modulation units is 50-200.

14. The method according to claim 7, wherein in the annular SP-LPG sensor, the refractive index modulation units are periodically distributed along the axial direction of the fiber core according to a specific duty ratio; and the specific duty ratio is 1-50%.

15. The method according to claim 7, wherein in the annular SP-LPG sensor, the optical fiber is a single-mode fiber; and a laser is a femtosecond laser.

16. The method according to claim 7, wherein in the annular SP-LPG sensor, a diameter of the annulus is 1-10 μm, a number of annuli in each refractive index modulation unit is 1-10, a distance between the annuli in each refractive index modulation unit is 0.1-2 μm, a distance between adjacent refractive index modulation units is 10-80 μm, and a number of the refractive index modulation units is 50-200.

17. A method of using the annular SP-LPG sensor prepared by the preparation method according to claim 5 in a fiber-optic biochemical sensor or a temperature sensor.

18. The method according to claim 17, wherein in the preparation method, conditions of the laser are as follows: a wavelength of a femtosecond pulse laser is 520 nm, a repetition rate is 100-200 kHz, and an energy is 10-200 nJ.

19. The preparation method according to claim 11, wherein conditions of the laser are as follows: a wavelength of a femtosecond pulse laser is 520 nm, a repetition rate is 100-200 kHz, and an energy is 10-200 nJ.

20. The preparation method according to claim 12, wherein conditions of the laser are as follows: a wavelength of a femtosecond pulse laser is 520 nm, a repetition rate is 100-200 kHz, and an energy is 10-200 nJ.
